(19) United States
(12) Patent Application Publication
(10) Pub. No.: US 2011/0029239 A1
(43) Pub. Date: Feb. 3, 2011

(54) NAVIGATION SYSTEM, IN-VEHICLE DEVICE, NAVIGATION METHOD, AND COMPUTER-READABLE MEDIUM

(75) Inventors: Kazuhiro OKUDE, Kobe-shi (JP); Yoshiji Ishizuka, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/842,375

(22) Filed: Jul. 23, 2010

(30) Foreign Application Priority Data
Jul. 31, 2009 (JP) 2009-179626

(51) Int. Cl. G01C 21/32

(52) U.S. Cl. 701/211

(57) ABSTRACT

A navigation system is provided. An in-vehicle device is mounted on a vehicle. A data providing apparatus provides data regarding navigation to the in-vehicle device. The data providing apparatus detects current position data of the vehicle, accumulates map image data, cuts the map image data in a display size of the in-vehicle device, and separately transmits the detected current position data and the cut map image data to the in-vehicle device. The in-vehicle device receives the current position data and the cut map image data from the data providing apparatus, and superimposes the received current position data and the cut map image data to display a guide image. The current position data is transmitted in a first transmission cycle and the cut map image data is transmitted in a second transmission cycle which is shorter than the first transmission cycle. The current position data is updated while maintaining the cut map image data when the current position data is received, and the cut map image data is updated when the current position data is located at an update position in the periphery of the cut map image data.

The disclosure of Japanese Patent Application No. 2009-179626 filed on Jul. 31, 2009 including specification, drawings and claims is incorporated herein by reference in its entirety.

### BACKGROUND

The present invention relates to a technique which implements a navigation function by providing a map image from a data providing apparatus to an in-vehicle device mounted on a vehicle.

In a car navigation system, GPS data representing where a vehicle is currently located on earth is calculated by using a global positioning system (GPS), and a host-vehicle position mark is superimposed on a map image and displayed on a display of an in-vehicle device on the basis of GPS data. FIG. 1 is a configuration diagram showing the car navigation system. The in-vehicle device is mounted on a vehicle, such as an automobile 5. GPS data is calculated on the basis of electric waves emitted from three or more GPS satellites 4 and received by the in-vehicle device. With regard to the superimposition processing of the host-vehicle position mark and map image data, as shown in FIG. 2, the host-vehicle position mark d is fixedly displayed at a predetermined position of map image data displayed on the display, the host-vehicle position mark d is set as a current position, and map image data is updated and displayed in accordance with GPS data which changes with the movement of the vehicle. That is, a periphery map according to the movement of the vehicle is updated and displayed, such that display is carried out as if the host-vehicle position mark d is moving. For example, map image data is updated and displayed from map image data G1 to G2 and from G2 to G3 of FIG. 2.

With the improvement in performance of a mobile terminal, such as a mobile phone or a PDA (Personal Digital Assistant), in such a mobile terminal, a navigation system using a GPS is implemented. In such a navigation system, a mobile terminal and a server which performs wireless communication with the mobile terminal share functions. With regard to function sharing, for example, the mobile terminal has a position data acquisition function, a destination setting function, a map matching function, a display function, and the like. Further, the server has a map image accumulation function, a route search function, a map image cutting function, and the like. Such function sharing enables resource distribution and sharing, such that costs can be reduced.

However, if a user who is carrying a navigation system-mounted terminal gets into a vehicle in which a car navigation system is mounted, the resources which implement a navigation function are redundant. As a system which eliminates the redundancy of the resources to effectively utilize the resources, a car navigation system is known in which an in-vehicle device, a mobile terminal, and a server share data necessary for navigation while the resources are distributed. For example, Patent Document 1 describes a technique in which an in-vehicle device acquires map images for navigation from a server by communication through a mobile phone.

Patent Document 1: JP-A-2002-107169

As described above, in a system in which navigation data is provided from a data providing apparatus, such as a server or a mobile terminal, to an in-vehicle device, the server has a map image data accumulation function to accumulate map image data, a route search function, a route periphery map image data extraction function, and the like. Further, the mobile terminal has a map image cutting function, a GPS data detection function, and a coordinate data calculation function, and the in-vehicle device has a display function of map image data or the like. In order to exhibit such functions, it is important that sufficient communication capacity is provided between the devices (for example, between the server and the mobile terminal, and between the mobile terminal and the in-vehicle device) serving as the elements for collaboration of the functions.

That is, when communication capacity for collaboration of the functions is low, collaboration of the functions may be inferior, and the functions of the navigation system may not be sufficiently exhibited.

For example, when a vehicle is traveling at a high speed equal to or higher than a vehicle speed 40 km and position data which is acquired from a GPS communication section mounted on the in-vehicle device changes quickly, processing for acquiring map image data having a comparatively large amount of data may be delayed due to delay of a communication speed or the like, and a host-vehicle position mark representing a current position and appropriate map image data corresponding to the host-vehicle position mark may not be displayed on a display section of the in-vehicle device. That is, in a guide image of navigation, the host-vehicle position mark may be significantly shifted from the actual position of the vehicle.

### SUMMARY

It is therefore an object of at least one embodiment of the present invention to provide a navigation system which provides navigation data from a data providing apparatus to an in-vehicle device capable of performing display such that, in a guide image of navigation, the correspondence relationship between current position data of a vehicle and map image data represents the actual position of the vehicle.

In order to achieve the above described object, according to a first aspect of at least one embodiment of the present invention, there is provided a navigation system, comprising: an in-vehicle device mounted on a vehicle; and a data providing apparatus that provides data regarding navigation to the in-vehicle device, wherein the data providing apparatus includes: a detection unit that detects current position data of the vehicle; an accumulation unit that accumulates map image data; a map image cutting unit that cuts the map image data in a display size of the in-vehicle device; and a transmission unit that separately transmits the current position data which is detected by the detection unit and the cut map image data which is cut by the map image cutting unit to the in-vehicle device, wherein the in-vehicle device includes: a reception unit that receives the current position data and the cut map image data from the data providing apparatus; and a display unit that superimposes the received current position data and the cut map image data to display a guide image, wherein the transmission unit transmits the current position data in a first transmission cycle and transmits the cut map image data in a second transmission cycle which is shorter than the first transmission cycle, and wherein the display unit updates the current position data while maintaining the cut map image data when the reception unit receives the current position data, and updates the cut map image data when the current position data is located at an update position in the periphery of the cut map image data.

According to the above aspect, the data providing apparatus sets the transmission cycle of the current position data, which is updated with greater frequency and has a smaller amount of data than cut map image data, to be shorter than the transmission cycle of cut map image data. Thus, there is no case where update and display processing is delayed in the in-vehicle device. Therefore, current position data of the vehicle can be reflected substantially in real time. That is, the correspondence relationship between current position data of the vehicle and map image data which are superimposed on the guide image can be constantly established so as to represent the actual position of the vehicle.

The data providing apparatus may further include a vehicle speed detection unit that detects a vehicle speed of the vehicle, the transmission unit may transmit decoration data for decorating the cut map image data to the in-vehicle device when the vehicle speed is equal to or lower than a predetermined vehicle speed, and the display unit may superimpose the received current position data, the cut map image data and the decoration data to display the guide image.

With this configuration, when the vehicle speed of the vehicle is low or the vehicle is stopping, it is considered that, even when display accuracy of current position data is slightly inferior, there is no problem. In this case, decoration data for decorating map image data is transmitted, such that decoration data can be appropriately displayed on the guide image, and there is no influence on communication of other kinds of data.

The transmission unit may transmit display sequence data which indicates a sequence for superimposing the current position data and the cut map image data to display the guide image, and the display unit may superimpose the current position data and the cut map image data on the basis of the display sequence data.

With this configuration, data for use in the guide image transmitted at different transmission timing can be superimposed in an appropriate sequence.

The map image cutting unit may cut a route map image according to a guidance route to a destination and an adjacent map image adjacent to the route map image as the cut map image data, and the display unit of the in-vehicle device may select one of the route map image and the adjacent map image as the cut map image data for use in the guide image on the basis of the current position data.

With this configuration, even when current position data is outside a guidance route, appropriate cut map image data can be used in the guide image on the basis of current position data.

According to a second aspect of at least one embodiment of the present invention, there is provided an in-vehicle device that is mounted on a vehicle and that receives data regarding navigation from a data providing apparatus, wherein the data providing apparatus detects current position data of the vehicle, accumulates map image data, cuts the map image data in a display size of the in-vehicle device, and separately transmits the detected current position data and the cut map image data to the in-vehicle device, and wherein the data providing apparatus transmits the detected current position data in a first transmission cycle and transmits the cut map image data in a second transmission cycle which is shorter than the first transmission cycle, the in-vehicle device comprising: a reception unit that receives the current position data and the cut map image data from the data providing apparatus; and a display unit that superimposes the received current position data and the cut map image data to display a guide image, wherein the display unit updates the current position data while maintaining the cut map image data when the reception unit receives the current position data, and updates the cut map image data when the current position data is located at an update position in the periphery of the cut map image data.

The reception unit may receive display sequence data which indicates a sequence for superimposing the current position data and the cut map image data to display the guide image, from the data providing apparatus, and the display unit may superimpose the current position data and the cut map image data on the basis of the display sequence data.

According to a third aspect of at least one embodiment of the present invention, there is provided a navigation method for a navigation system including: an in-vehicle device which is mounted on a vehicle; and a data providing apparatus which provides data regarding navigation to the in-vehicle device, the navigation method comprising: a detection step of causing the data providing apparatus to detect current position data of the vehicle; a map image cutting step of causing the data providing apparatus to cut map image data which is accumulated in the data providing apparatus in a display size of the in-vehicle device; a transmission step of causing the data providing apparatus to separately transmit the detected current position data and the cut map image data to the in-vehicle device; a reception step of causing the in-vehicle device to receive the current position data and the cut map image data from the data providing apparatus; and a display step of causing the in-vehicle device to superimposes the received current position data and the cut map image data to display a guide image, wherein in the transmission step, the current position data is transmitted in a first transmission cycle and the cut map image data is transmitted in a second transmission cycle which is shorter than the first transmission cycle, and wherein in the display step, the current position data is updated while maintaining the cut map image data when the current position data is received, and the cut map image data is updated when the current position data is located at an update position in the periphery of the cut map image data.

According to a fourth aspect of at least one embodiment of the present invention, there is provided a computer-readable medium recording a program which is executable in a computer of an in-vehicle device that is mounted on a vehicle and that receives data regarding navigation from a data providing apparatus, wherein the data providing apparatus detects current position data of the vehicle, accumulates map image data, cuts the map image data in a display size of the in-vehicle device, and separately transmits the detected current position data and the cut map image data to the in-vehicle device, and wherein the data providing apparatus transmits the detected current position data in a first transmission cycle and transmits the cut map image data in a second transmission cycle which is shorter than the first transmission cycle, the program which causes the computer of the in-vehicle device to perform a navigation method comprising: a reception step of causing the in-vehicle device to receive the current position data and the cut map image data from the data providing apparatus; and a display step of causing the in-vehicle device to superimposes the received current position data and the cut map image data to display a guide image, wherein in the display step, the current position data is updated while maintaining the cut map image data when the current position data is received, and the cut map image data is updated when the current position data is located at an update position in the periphery of the cut map image data.

### BRIEF DESCRIPTION OF THE DRAWINGS

In the accompanying drawings:

FIG. 1 is a diagram illustrating a navigation system;

FIG. 2 is a diagram illustrating a display map image in a navigation system;

FIG. 3 is a diagram illustrating a navigation system according to an embodiment of the present invention;

FIG. 4 is a system block diagram illustrating an in-vehicle device according to the embodiment;

FIG. 5 is a system block diagram illustrating a mobile terminal according to the embodiment;

FIG. 6 is a system block diagram illustrating a server according to the embodiment;

FIG. 7 is a flowchart illustrating an operation of the navigation system according to the embodiment;

FIG. 8 is a flowchart illustrating an operation of the navigation system according to the embodiment;

FIG. 9 is a flowchart illustrating an operation of the navigation system according to the embodiment;

FIG. 10 is a flowchart illustrating an operation of the navigation system according to the embodiment;

FIG. 11 is a flowchart illustrating an operation of the navigation system according to the embodiment;

FIG. 12 is a flowchart illustrating an operation of the navigation system according to the embodiment;

FIG. 13 is a flowchart illustrating an operation of the navigation system according to the embodiment;

FIG. 14 is a flowchart illustrating an operation of the navigation system according to the embodiment;

FIG. 15 is a flowchart illustrating an operation of the navigation system according to the embodiment;

FIG. 16 is a flowchart illustrating an operation of the navigation system according to the embodiment;

FIG. 17 is a diagram illustrating route periphery map image data in the navigation system;

FIG. 18 is a diagram illustrating cut map image data in the navigation system;

FIG. 19 is a diagram illustrating the configuration of data;

FIG. 20 is a diagram illustrating superimposing display of data; and

FIG. 21 is a diagram illustrating the configuration of a navigation system.

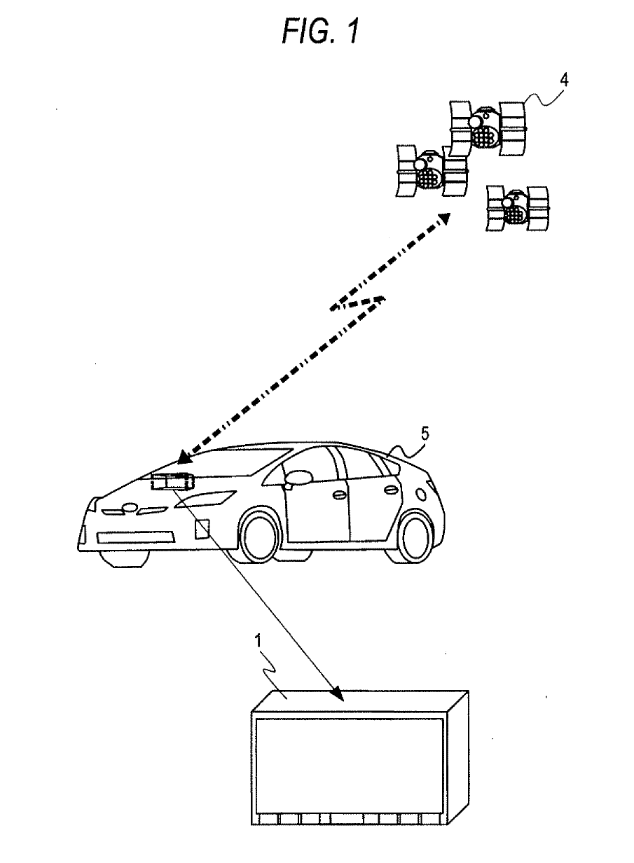

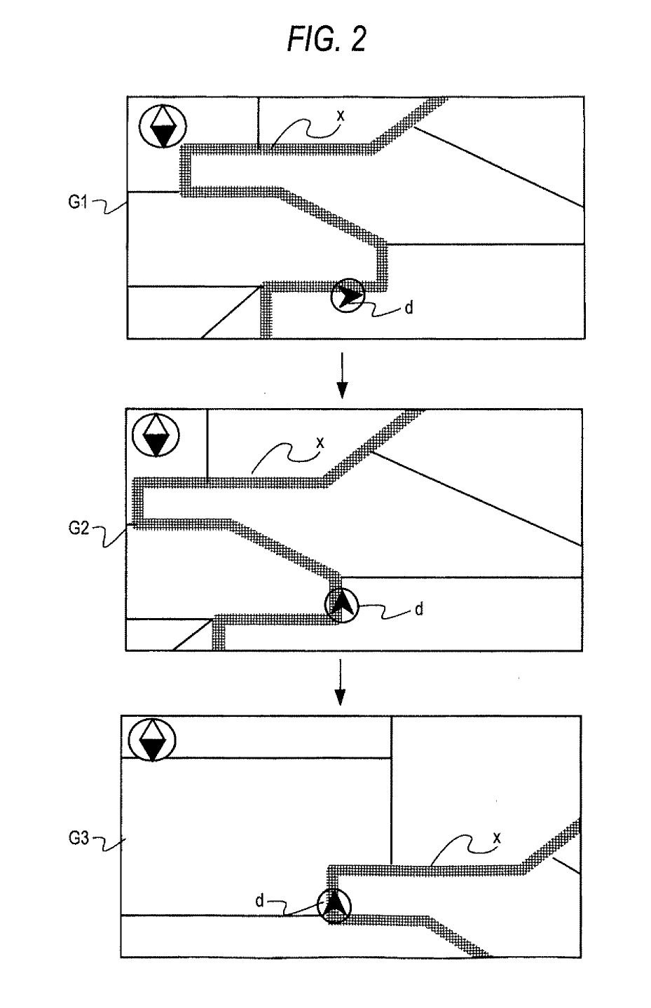

### DETAILED DESCRIPTION OF THE EMBODIMENTS

Hereinafter, exemplary embodiments of the present invention will be described with reference to the accompanying drawings.

### 1. First Embodiment

<1.1 Configuration of Navigation System>

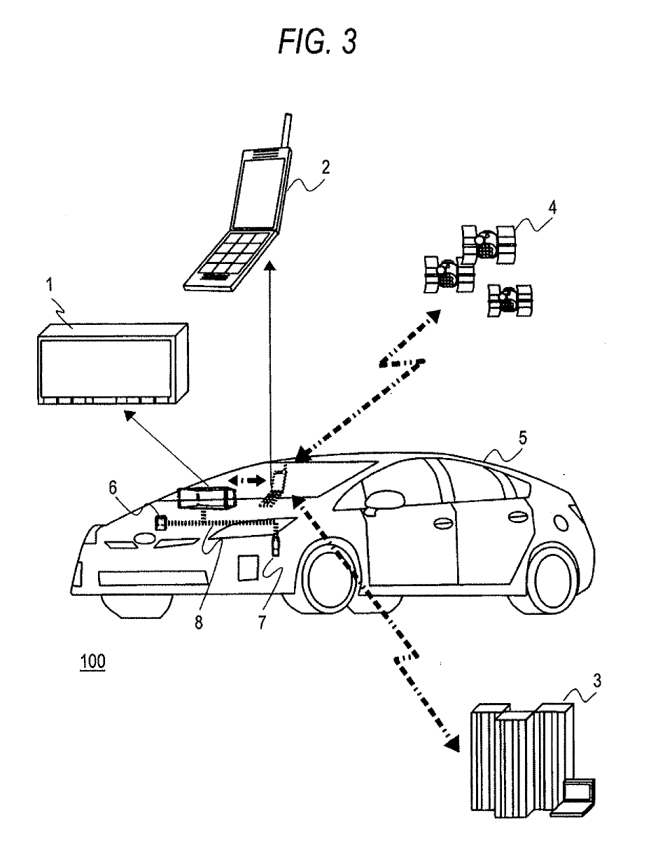

FIG. 3 is a schematic view showing the configuration of a navigation system 100 of a first embodiment. The navigation system 100 includes an in-vehicle device 1 which is mounted on a vehicle, such as an automobile 5, and a mobile terminal 2 and a server 3 which serve as a data providing apparatus. The in-vehicle device 1 performs near field communication based on the Bluetooth (Registered Trademark) standard with the mobile terminal 2 to transmit and receive data regarding navigation and the like. With regard to communication, wired communication by USB connection or the like may be used. The mobile terminal 2 performs near field communication with the in-vehicle device 1 to transmit and receive data regarding navigation and the like, and performs wireless communication with GPS satellite 4 to receive data for measuring a current position and the like. Further, the mobile terminal 2 performs wireless communication with the server 3 to transmit and receive data regarding navigation and the like. The GPS satellites 4 perform wireless communication with the mobile terminal 2 to transmit data for measuring a current position and the like. The server 3 performs wireless communication with the mobile terminal 2 to transmit and receive data regarding navigation and the like. The navigation system 100 is configured such that the in-vehicle device 1, the mobile terminal 2, and the server 3 implement a navigation function described below on the basis of data acquired by such communication.

In the navigation system 100 of this embodiment, the mobile terminal 2 and the server 3 operate collaboratively to provide data regarding navigation to the in-vehicle device 1. Thus, the mobile terminal 2 and the server 3 are combined to constitute a data providing apparatus which provides data regarding navigation to the in-vehicle device 1.

In this navigation system 100, GPS data, current position coordinate data (described below) calculated on the basis of GPS data, and a host-vehicle position mark d are data for representing the position of the vehicle on earth. Thus, such data may be referred to as current position data.

In the related art, a navigation method is used in which the host-vehicle position mark d representing the current position is fixed on the display screen of the in-vehicle device, and map image data in the periphery of the current position is updated and displayed in accordance with the movement of the vehicle. In contrast, in the navigation system of the invention, a navigation method is used in which the host-vehicle position mark d is updated and displayed so as to move on the map in accordance with the movement of the vehicle while the displayed map is maintained, and only when the host-vehicle position mark d moves away from the map, map image data is updated and displayed.

With this configuration, it is possible to eliminate the problem that, in the in-vehicle device 1, processing for acquiring map image data having a comparatively large amount of data is delayed due to delay of the transmission speed, and map image data corresponding to the host-vehicle position mark d representing the current position may not be superimposingly displayed on the display section of the in-vehicle device. Detailed means for eliminating the problem will be described below.

<1.1.1 System Block Diagram>

(In-Vehicle Device)

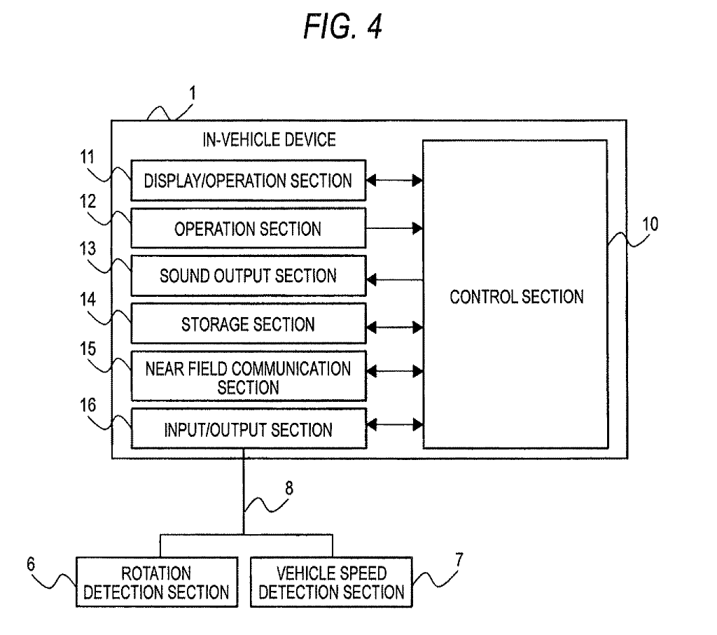

FIG. 4 is a system block diagram of the in-vehicle device 1. The in-vehicle device 1 includes a control section 10 which performs various kinds of control for implementing a navigation function or a music play function, a display/operation section 11 (for example, a touch panel) which highlights a route z to a destination to display a map image and the like serving as a guide screen for guidance to the destination and receives a user's operation, an operation section 12 which receives other user's operations, a sound output section 13 which outputs music or sound effect at the time of operation, a storage section 14 (for example, a flash memory) which stores data necessary for control, a near field communication section 15 which performs communication based on the Bluetooth (Registered Trademark) standard with a communication destination within a predetermined distance, for example, within 10 to 100 m radius, and an input/output section 16 (I/F). The input/output section 16 receives signals representing detection values from a rotation detection section 6 (for example, a gyro sensor) and a vehicle speed detection section 7 (for example, a vehicle speed sensor), which are connected to an in-vehicle network 8 (for example, a control area network), through the in-vehicle network. The rotation detection section 6 detects rotation in the traveling direction of the vehicle and the vehicle speed detection section 7 detects the traveling speed of the vehicle. The rotation detection section 6 and the vehicle speed detection section 7 are external devices which are provided separately from the in-vehicle device 1 in the vehicle.

When the navigation function is implemented, a guide screen is displayed on the display/operation section 11. Data regarding navigation, such as a map image or position data provided from the mobile terminal 2, is received by the near field communication section 15, and data regarding navigation which is transmitted from the in-vehicle device 1 to the mobile terminal 2 is transmitted by the near field communication section 15.

The control section 10 is constituted by a microcomputer including a CPU and the like. The CPU carries out arithmetic processing in accordance with a program stored in a predetermined memory (for example, a ROM), such that the control section 10 implements a function regarding the navigation system. The program is stored in the storage section 14 or the like in advance, but the program may be updated by communication with an external server or by reading a recording medium in which the program is stored.

The navigation function which is implemented by the control section 10 mainly includes the following functions (A) to (D).

(A) A display function such that the control section 10 displays the guide image, on which cut map image data, decoration data, and the host-vehicle position mark received by the near field communication section 15 are superimposed, on the display/operation section 11.

(B) A decoration data update and display control function such that the control section 10 updates decoration data received by the near field communication section 15 on the guide image displayed on the display/operation section 11.

(C) A host-vehicle position mark update and display control function such that the control section 10 updates the host-vehicle position mark d received by the near field communication section 15 on the guide image displayed on the display/operation section 11.

(D) A cut map image data update and display control function such that, when current position coordinate data received by the near field communication section 15 is included at an update position, the control section 10 updates cut map image data on the guide image displayed on the display/operation section 11.

The details of these functions will be described below in detail.

The control section 10 controls the respective sections of the in-vehicle device 1 to execute the steps necessary for implementing a navigation function described below.

(Mobile Terminal)

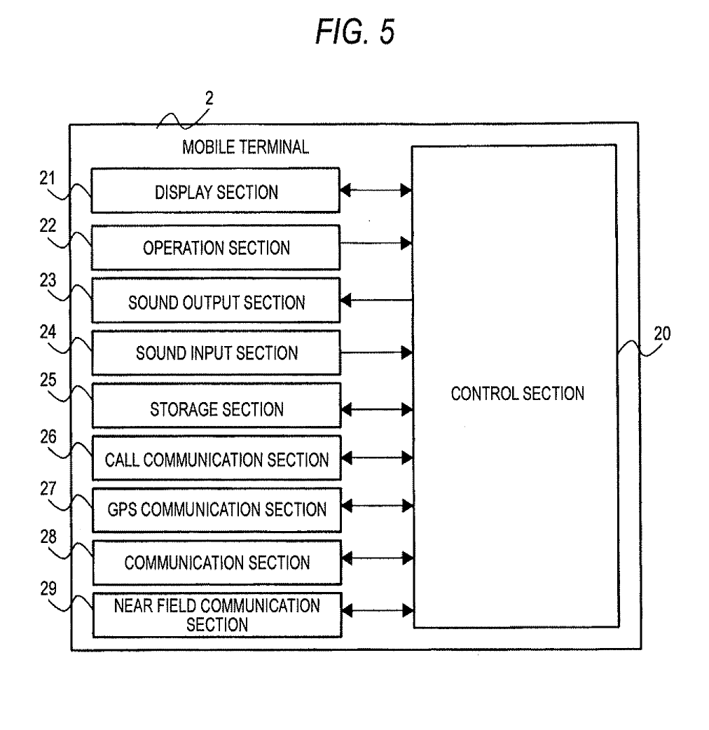

FIG. 5 is a system block diagram of the mobile terminal 2. The mobile terminal 2 includes a control section 20 which performs various kinds of control for implementing a call function and a navigation function, a display section 21 which displays a telephone number and the like at the time of a call, an operation section 22 which receives a user's operation, a sound output section 23 which outputs voice of a communication destination at the time of a call, sound effect at the time of operation, or ring tone when an E-mail is incoming, a sound input section 24 which inputs voice of a user who talks with a communication destination at the time of a call, a storage section 25 (for example, a flash memory) which stores data necessary for control, a call communication section 26 which transmits and receives call data for making a call with another mobile terminal by wireless communication, a GPS communication section 27 which receives signals transmitted from the GPS satellites 4, a communication section 28 which transmits and receives data regarding navigation to and from the server by wireless communication, and a near field communication section 29 which can perform data communication based on the Bluetooth (Registered Trademark) standard with a communication destination within a predetermined distance, for example, within 10 to 100 m radius.

At the scene where the navigation system 100 of this embodiment functions, a user (a driver of the vehicle) carries the mobile terminal 2, such that the mobile terminal 2 is located inside the vehicle. Thus, the GPS communication section 27 acquires GPS data which becomes current position data of the vehicle.

The control section 20 is constituted by a microcomputer including a CPU and the like. The CPU carried out arithmetic processing in accordance with a program stored in a predetermined memory (for example, a ROM), such that the control section 20 implements a function regarding navigation. The program is stored in the storage section 25 or the like in advance, but the program may be updated by communication with an external server or by reading a recording medium in which the program is stored.

The navigation function which is implemented by the control section 20 mainly includes the following functions (E) to (J).

(E) A current position coordinate data calculation function such that the control section 20 calculates current position coordinate data representing where the host-vehicle position mark is located on route periphery map image data on the basis of GPS data received by the GPS communication section 27.

(F) A map image cutting function such that the control section 20 cuts the amount of data suitable for the size displayed on the display/operation section 11 of the in-vehicle device 1 from route periphery map image data received from the server 3 by the communication section 28.

(G) A data processing function such that the control section 20 processes cut map image data, decoration data received from the server 3 by the communication section 28, and current position coordinate data.

(H) A decoration data control function such that the control section 20 transmits decoration data on the basis of vehicle speed data received from the in-vehicle device 1 by the near field communication section 29.

(I) A current position coordinate data control function such that the control section 20 calculates the coordinate on the cut map image data at which the host-vehicle position mark d is located on the basis of GPS data received by the GPS communication section 27, and transmits calculated data to the in-vehicle device 1 at a predetermined timing.

(J) A cut map image data control function such that the control section 20 transmits a cut map image to the in-vehicle device 1 at a predetermined timing.

The details of these functions will be described below in detail.

The control section 20 controls the respective sections of the mobile terminal 2 so as to execute the steps necessary for implementing a navigation function described below.

(Server)

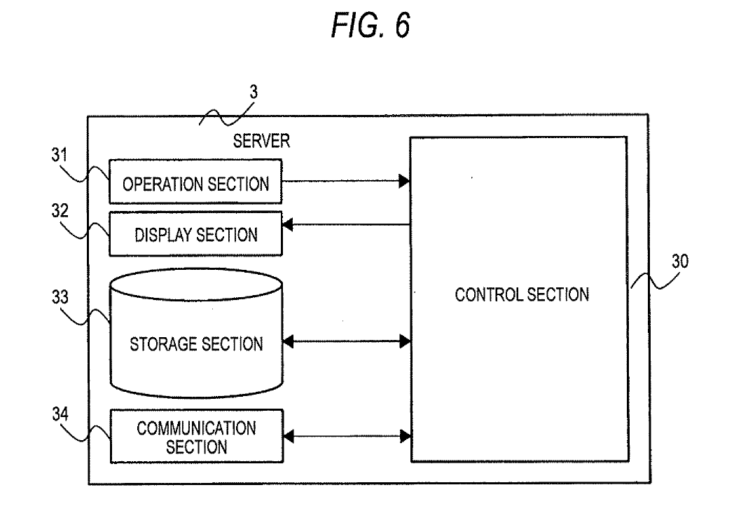

FIG. 6 is a system block diagram of the server 3. The server 3 includes a control section 30 which performs various kinds of control so as to implement a contents providing function, such as navigation information, an operation section 31 which receives an operation of an administrator for settings necessary for control or maintenance or the like of a control program or control data, a display section 32 which displays a setup screen or a maintenance screen, a storage section 33 which accumulates contents, such as map images, and a communication section 34 which transmits and receives data regarding navigation and the like to and from the mobile terminal 2 by wireless communication.

The control section 30 is constituted by a microcomputer including a CPU and the like. The CPU carries out arithmetic processing in accordance with a program stored in a predetermined memory (ROM), such that the control section 30 implements a function regarding navigation.

The navigation function which is implemented by the control section 30 mainly includes the following functions (K) to (M).

(K) A route creation function such that the control section 30 creates a guidance route on the basis of GPS data and destination data of the vehicle received from the mobile terminal 2 by the communication section 34.

(L) A route periphery image creation function such that the control section 30 cuts a map image in the periphery of the route from the storage section 33 on the basis of the created route.

(M) A decoration data creation function such that the control section 30 extracts decoration data for decorating route periphery image data from the storage section 33.

The details of these functions will be described below in detail.

The control section 30 controls the respective sections of the server 3 so as to execute the steps necessary for implementing a navigation function described below.

<1.1.3 Navigation System Control Processing>

<Mobile Collaboration Control Processing>

(In-Vehicle Device)

Control processing which is carried out by the control section 10 provided in the in-vehicle device 1 will be described. When the user operates an ignition key of the vehicle and an ACC (accessory) is turned on, the control section 10 is supplied with power from a power supply (battery) and can carry out various kinds of control processing. If the control section 10 can carry out various kinds of control processing, control processing is carried out according to the contents operated by the user on the display/operation section 11 or the operation section 12. For example, the in-vehicle device 1 displays a menu for allowing the user to select various functions, such as a navigation function, a music play function, a mobile collaboration function, and the like on the display/operation section 11. When the user selects the mobile collaboration function on the menu, the control section 10 carries out control processing for implementing the mobile collaboration function.

In implementing the mobile collaboration function, it is necessary to perform pairing control so as to establish communication with the mobile terminal 2 or the server 3. The term “pairing control” refers to control such that the control section 20 of the mobile terminal 2 controls the near field communication section 21 to establish wireless communication with the near field communication section 15 of the in-vehicle device 1, and the control section 20 controls the communication section 28 to establish wireless communication with the communication section 34 of the server 3.

After pairing control has been established, the control section 10 of the in-vehicle device 1 displays a plurality of contents providing service menu on the display/operation section 11. For example, the menu includes a navigation providing service, a music providing service, and a menu providing service. When the navigation service is selected, the control section 10 of the in-vehicle device 1 executes the selected navigation system in collaboration with the mobile terminal 2 and the server 3.

(Mobile Terminal)

Control processing which is carried out by the control section 20 provided in the mobile terminal 2 will be described. When a power button provided in the mobile terminal is turned on, the control section 20 is supplied with power from the power supply (battery) and can carry out various kinds of control processing. If the control section 20 can carry out various kinds of control processing, control processing is carried out in accordance with the contents operated by the user on the operation section 22. For example, the mobile terminal 2 is configured such that the user can operate various functions, such as a call function, an Internet browsing function, and a mobile collaboration function on the operation section 22. When the user selects the mobile collaboration function on the operation section 22, the control section 20 carries out pairing control processing so as to implement the mobile collaboration function.

After pairing control has been established, when the navigation service is selected on the in-vehicle device 1, the control section 20 executes the navigation providing service in collaboration with the in-vehicle device 1 and the server 3.

(Server)

Control processing which is carried out by the control section 30 provided in the server 3 will be described. When the administrator operates a power button provided in the server 3 and the power button is turned on, the control section 30 is supplied with power from a power supply (commercial power supply) and can carry out various kinds of control processing. If the control section 30 can carry out various kinds of control processing, control processing according to the contents operated by the administrator on the operation section 31 or contents providing control processing is carried out. That is, if the administrator operates the operation section 31 to select to carry out contents providing control processing, the control section 30 provides contents, such as map images, in accordance with a request from a client, such as the in-vehicle device 1 or the mobile terminal 2. If a request to carry out pairing control is input from the mobile terminal 2 so as to implement the mobile collaboration function, pairing control is carried out in accordance with the request.

After pairing control has been established, when the navigation service is selected on the in-vehicle device 1, the control section 30 executes the navigation providing service in collaboration with the mobile terminal 2 and the server 3.

Hereinafter, when the user selects the navigation providing service on the contents providing service menu displayed on the display/operation section 11 of the in-vehicle device 1, control of the in-vehicle device 1, the mobile terminal 2, and the server 3 will be described.

<Navigation Control Processing>

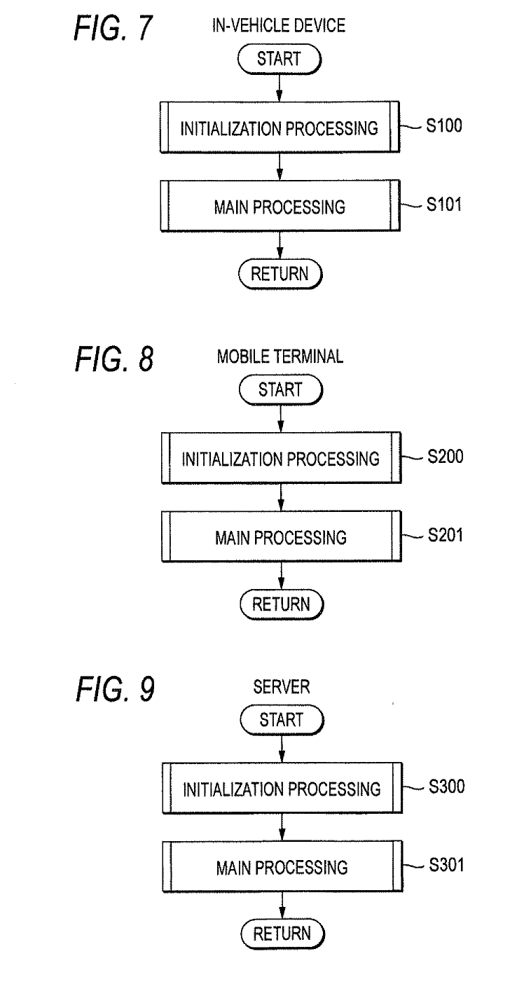

FIG. 7 illustrates a navigation providing service which is executed by the navigation system 100. The control section 10 of the in-vehicle device 1, the control section 20 of the mobile terminal 2, and the control section 30 of the server 3 execute a main routine shown in FIG. 7.

<Main Routine>

The main routines which are executed by the respective control sections will be described with reference to FIGS. 7, 8, and 9.

The main routine in the in-vehicle device 1 will be described on the basis of FIG. 7.

In S100, the control section 10 of the in-vehicle device 1 carries out initialization processing which is a subroutine. The initialization processing refers to processing for providing, acquiring, and displaying data which is initially required when the in-vehicle device 1 which constitutes part of the navigation system 100 carries out navigation processing. After having carried out the initialization processing, the control section 10 progresses to S101,

In S101, the control section 10 carries out main processing which is a subroutine. The main processing refers to processing for providing, acquiring, and displaying data which is required while the in-vehicle device 1 which constitutes part of the navigation system 100 is carrying out the navigation processing. After having carried out the initialization processing, the control section 10 ends the navigation providing service and returns to the original control processing.

The main routine in the mobile terminal 2 will be described on the basis of FIG. 8.

In S200, the control section 20 of the mobile terminal 2 carries out initialization processing which is a subroutine. Similarly to the above-described initialization processing, the initialization processing is carried out by the mobile terminal 2. After having carried out the initialization processing, the control section 20 progresses to S201.

In S201, the control section 20 carries out main processing which is a subroutine. Similarly to the above-described main processing, the main processing is carried out by the mobile terminal 2. After having carried out the initialization processing, the control section 20 ends the navigation providing service and returns to the original control processing.

The main routine in the server 3 will be described on the basis of FIG. 9.

In S300, the control section 30 of the server 3 carries out initialization processing which is a subroutine. Similarly to the above-described initialization processing, the initialization processing is carried out by the server 3. After having carried out the initialization processing, the control section 30 progresses to S301.

In S301, the control section 30 carries out main processing which is a subroutine. Similarly to the above-described main processing, the main processing is carried out by the server 3. After having carried out the initialization processing, the control section 30 ends the navigation providing service and returns to the original control processing.

<Subroutine>

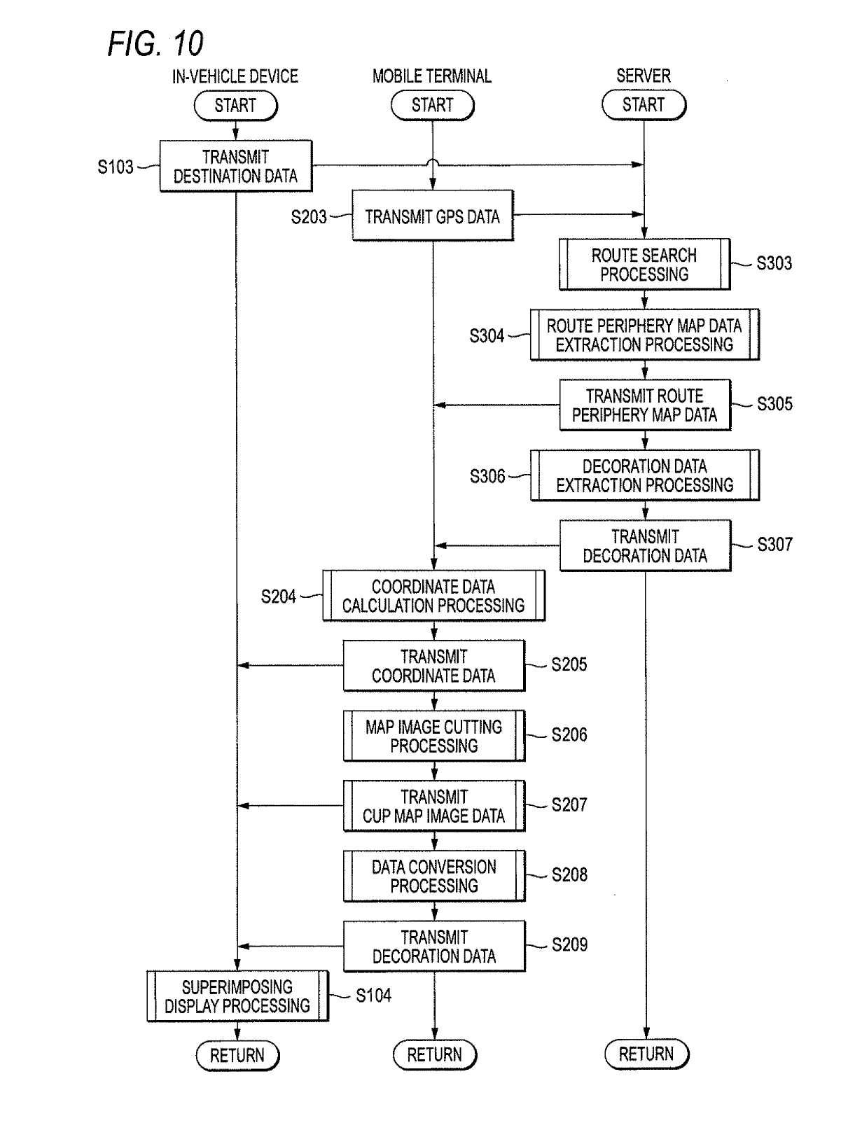

The subroutines which are executed by the respective control sections will be described on the basis of FIGS. 10, 11, 12, 13, 14, 15, and 16.

<1.2.2.3 Initialization Processing>

When the navigation system 100 carries out navigation processing, initialization processing is carried out for providing, acquiring, and displaying data which is initially required. The initialization processing will be described on the basis of FIG. 10.

<Route Search Processing>

In S103, the control section 10 of the in-vehicle device 1 transmits destination data set by the user to the server 3 through the mobile terminal.

In S203, the control section 20 of the mobile terminal 2 transmits GPS data to the server 3.

In S303, the control section 30 of the server 3 creates a traveling route on the basis of received destination data, GPS data, and map image data stored in the storage section 33 (map image database) by a route creation function. The creation of a route z is implemented, for example, by referring to the characteristics associated with roads from the current position of map image data to a destination and combining roads according to the concept of each route.

<Route Periphery Image Data Creation Processing>

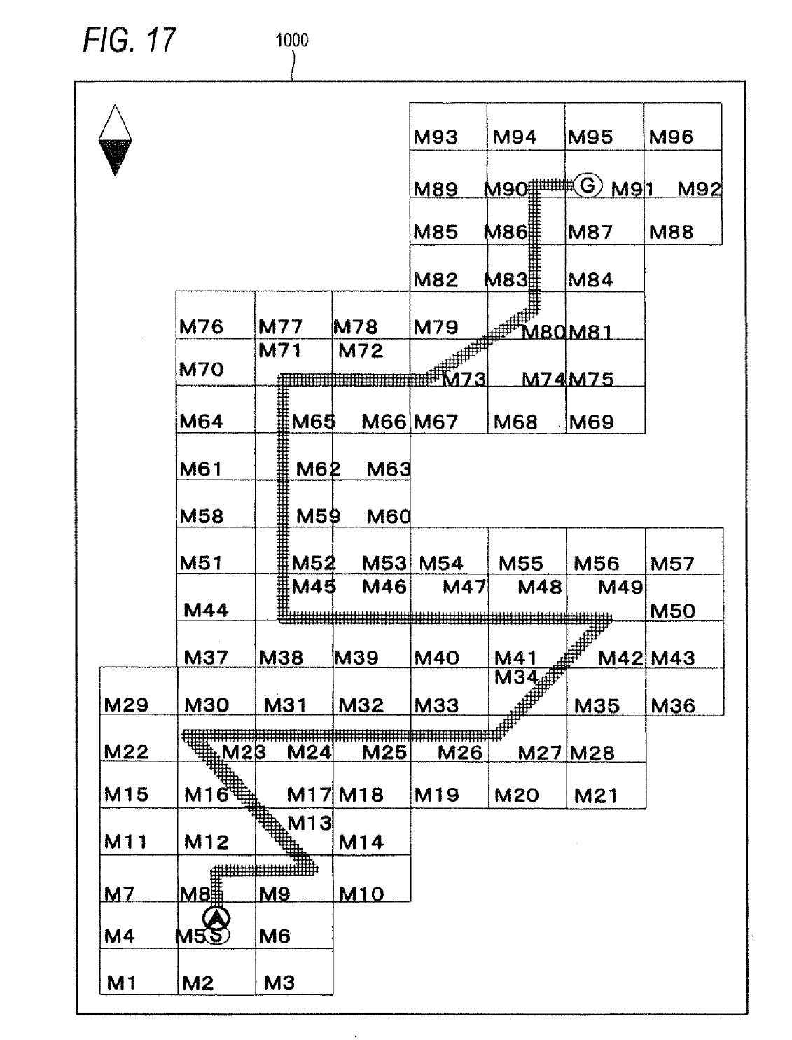

In S304, the control section 30 of the server 3 extracts map image data in the periphery of the created route from the storage section 33 by a route periphery image data creation function. For example, route periphery map image data 1000 shown in FIG. 17 is used. Route periphery map image data 1000 is appended with addresses. That is, when the lateral direction shown in FIG. 17 is the X axis and the longitudinal direction is the Y axis, a plurality of lines are set on each axis, and a numeral is set uniquely for each line. The address is constituted by numerals of the vertical axis (X) and the horizontal axis (Y), for example, like X:Y=350:20.

The address is required when superimposition processing described below is carried out for superimposing decoration data, the host-vehicle position mark d, and cut map image data in the display/operation section 11 of the in-vehicle device 1.

In S305, the control section 30 of the server 3 transmits extracted route periphery map image data 1000 to the mobile terminal 2.

<Decoration Data Extraction Processing>

In S306, the control section 30 of the server 3 extracts data for decorating route periphery map image data 1000 from the storage section 33 by a decoration data extraction function. Decoration data includes, for example, an address, a name, such as a street name, a place name, a station name, a school name, a fire department name, a police station name, a ward office name, a gymnasium name, or a park name, or a facility mark in route periphery map image data 1000, and is used to decorate route periphery map image data. Decoration data is appended with coordinate data representing an address of route periphery map image data 1000 where decoration data is located.

In S307, the control section 30 of the server 3 transmits decoration data to the mobile terminal 2.

<Current Position Coordinate Data Calculation Processing>

In S204, the control section 20 of the mobile terminal 2 calculates current position coordinate data by a current position coordinate data calculation function. GPS data representing the position of the vehicle on earth at the time of reception is calculated on the basis of the signals transmitted from the GPS satellites 4 and received by the GPS communication section 27. The control section 20 calculates current position coordinate data representing an address of route periphery map image data 1000 where the host-vehicle position mark d is located on the basis of GPS data. Current position coordinate data is constituted by numerals of the vertical axis (X) and the horizontal axis (Y), for example, like X:Y=100:15.

<Map Matching Processing>

The control section 20 of the mobile terminal 2 receives data (data representing speed, transmission gear, direction, and the like) from the in-vehicle device 1, and carries out map matching on the basis of data and coordinate data. The map matching is to determinate whether or not there is a similar portion between the traveling trace of the vehicle calculated on the basis of detection data of various sensors and the lines of the roads in the cut map images, when there is a similar portion, set the position to be “true”, calculate a difference coefficient k between the coordinate set to be “true” and current position coordinate data, and multiply current position coordinate data calculated by the current position coordinate data calculation processing by the difference coefficient k as a correction term.

In S205, the control section 20 of the mobile terminal 2 transmits current position coordinate data after map matching to the in-vehicle device 1. The in-vehicle device 1 stores the cut map images and current position coordinate data in the storage section 14.

<Map Image Cutting Processing>

In S206, the control section 20 of the mobile terminal 2 stores route periphery map image data 1000 received from the server 3 in the storage section 25, and cuts multiple pieces of map image data having different ranges along the route z from stored route periphery map image data 1000 with the amount of data of a size suitable for the guide image displayed on the display/operation section 11 of the in-vehicle device 1. The map images are hereinafter referred to as main cut map images.

For example, the main cut map images include map data of M5, M8, M9, M12, M13, M16, M17, M23, M24, M25, M26, M27, M34, M41, M42, M45, M46, M47, M48, M49, M52, M59, M62, M65, M71, M72, M73, M74, M80, M83, M86, M90, and M91 shown in FIG. 17.

The reason why such processing is carried out is that, since route periphery map image data 1000 includes the entire route z, route periphery map image data 1000 has an excessively large size and is not suitable for the guide image displayed on the display/operation section 11 of the in-vehicle device 1.

Cut map image data in the periphery of main cut map image data is also cut. The map images are hereinafter referred to as sub cut map image data. Sub cut map image data includes eight pieces of cut map image data in the periphery of main cut map image data with the amount of data of a size suitable for the guide image displayed on the display/operation section 11 of the in-vehicle device 1.

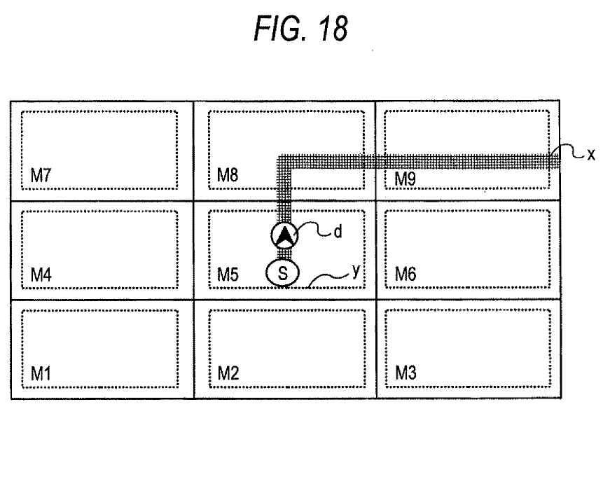

For example, main cut map image data is excluded from cut map image data of M1 to M96 shown in FIG. 17. Another example will be described on the basis of FIG. 18. FIG. 18 is an enlarged view of part of M1 to M7 which are part of FIG. 17. Eight pieces of sub cut map image data of main cut map image data M5 shown in FIG. 18 include map image data M2, M8, M4, and M6 adjacent main cut map image data on the upper, lower, left, and right sides and map image data M1, M3, M7, and M9 outside the four corners of main cut map image data,

The control section 20 of the mobile terminal 2 carries out the map image cutting processing to preliminarily cut the sub cut map images and transmits the sub cut map images to the in-vehicle device 1. Thus, in the guide image displayed on the display/operation section 11, even when the host-vehicle position mark d is deviated from the route z and moves away displayed map image data, since the control section 10 of the in-vehicle device 1 preliminarily prepares sub cut map image data, it is possible to avoid a situation where there is no map image data to be updated and displayed at that time.

In S207, the control section 20 of the mobile terminal 2 transmits a predetermined number of pieces of cut map image data, for example, nine pieces of cut map image data. Nine pieces of cut map image data include one piece of cut map image data where the host-vehicle position mark d is present and eight pieces of sub cut map image data of main cut map image data.

Cut map image data is appended with address data which is appended during the route periphery image data creation processing and a cut map image ID (for example, M1) which is newly set after being cut. This functions when the host-vehicle position mark d and the like are superimposed on the guide image displayed on the display/operation section 11 of the in-vehicle device 1 later. Details will be described below.

<Data Processing>

In S208, the control section 20 of the mobile terminal 2 carries out data processing to provide predetermined data to decoration data received from the server 3 or cut map image data cut from route periphery map image data 1000 by a data processing function.

Predetermined data to be appended includes an image ID (cut map image ID) for associating decoration data and cut map image data decorated by decoration data with each other when decoration data and cut map image data are superimposed and displayed on the guide image displayed on the display/operation section 11 by the control section 10, coordinate data representing an address of cut map image data where display is performed, and the host-vehicle position mark d which is appended to current position coordinate data.

When the control section 10 superimposes and displays data, such as decoration data and cut map image data, for use in the guide image on the display/operation section 11, data is classified by tiers and data in a deep layer is present at the rear surface rather than data in a shallow layer. Hereinafter, the tier is referred to as a layer. Thus, predetermined data which is appended to decoration data includes data representing a layer. Data representing a layer becomes display sequence data which represents a preferential display sequence (a sequence at the time of superimposition) at the rear surface of the guide image displayed on the display/operation section 11.

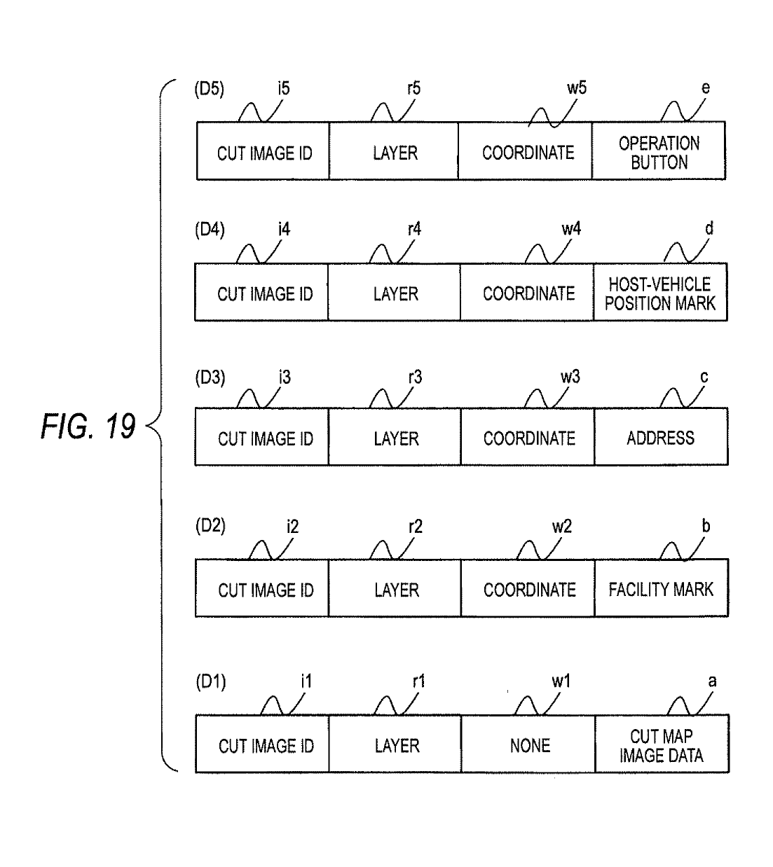

For example, data includes cut map image data, a facility mark, an address, the host-vehicle position mark d, and an operation button, and the above-described predetermined data is appended to such data. An example of data which is appended with predetermined data and processed will be described on the basis of FIG. 19.

D1 data is constituted by a cut map image ID i1, data L1 representing the deepest layer, an address w1, and cut map image data a.

D2 data is constituted by a cut map image ID i2, data L2 representing a layer shallower than L1, coordinate data w2, and a facility mark b.

D3 data is constituted by a cut map image ID i3, data L3 representing a layer shallower than L2, coordinate data w3, and an address c.

D4 data is constituted by a cut map image ID i4, data L4 representing a layer shallower than L3, coordinate data w4, and a host-vehicle position mark d.

D5 data is constituted by a cut map image ID i5, data L5 representing a layer shallower than L4, coordinate data w5, and an operation button e.

In S209, the control section 20 of the mobile terminal 2 transmits processed decoration data to the in-vehicle device 1.

<Superimposing Display Processing>

In S104, the control section 10 of the in-vehicle device 1 superimposes and displays data receives from the mobile terminal 2 on the guide image displayed on the display/operation section 11 by a superimposing display function.

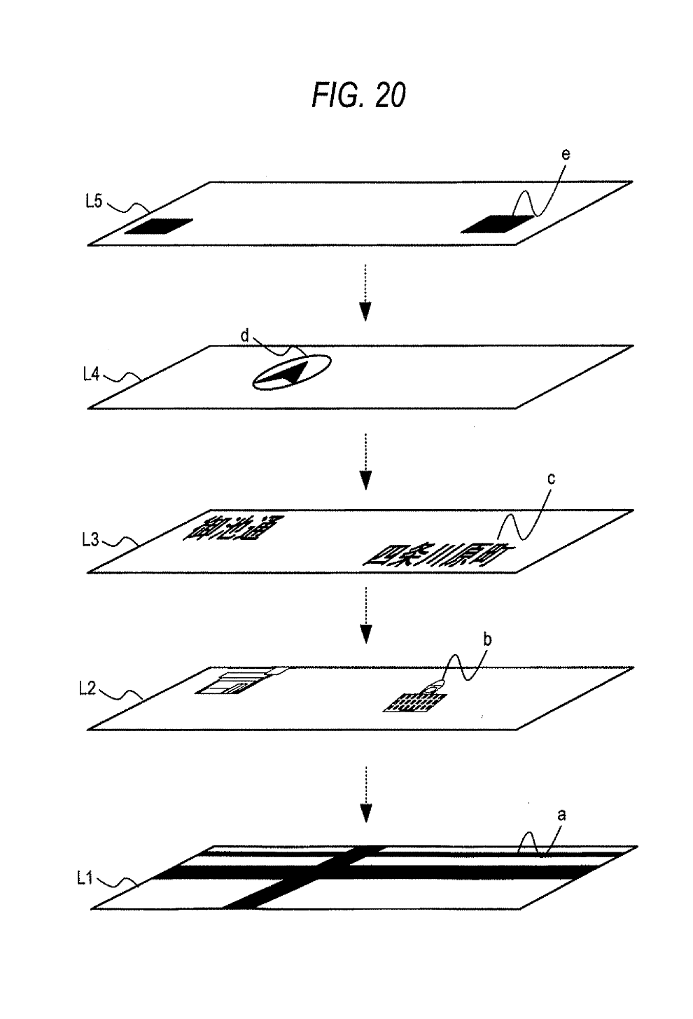

For example, as shown in FIG. 20, the control section 10 generates a guide image by superimposing cut map image data a included in D1 shown in FIG. 19 as the rearmost surface (L1), the facility mark b included in D2 as the front surface of L1 (L2), the address included in D3 as the front surface of L2 (L3), the host-vehicle position mark d included in D4 as the front surface of L3 (L4), and the operation button included in D5 as the front surface of L4 (L5) in accordance with the layers included in respective data.

With regard to the layers L2 to L5 other than L1, the control section 10 makes portions other than icon data or character data transparent to display data at the rear surface, and not to display data at the rear surface from the portions of icon data or character data. Since the layer L1 becomes the rearmost surface, all the map images other than data in the layer which becomes the front surface are not displayed.

The superimposing display is performed such that D1 data including an ID which is identical to the cut map image ID i4 of D4 data is referred to in the guide image displayed on the display/operation section 11 by the control section 10, and cut map image data a of D1 data is displayed as an image of the rearmost surface in accordance with the layer L1. In this case, the reason why superimposing display is performed on the basis of D4 data is that D4 data has the host-vehicle position mark d, and the reason why D1 data is referred to from D4 data is to select a cut map image where the host-vehicle position mark d from among nine cut map images received from the server 3 and stored in the storage section 14 of the in-vehicle device 1.

D2 data including the ID i4 is referred to, and the facility mark b of D2 data is displayed at the front surface from cut map image data a in accordance with the layer L2 and is also displayed at a location whose coordinate data is identical to the address appended to cut map image data a.

D3 data including the ID i4 is referred to, and the address c of D3 data is displayed at the front surface from the facility mark b in accordance with the layer L3 and is also displayed at a location whose coordinate data is identical to the address appended to cut map image data a.

D4 data including the ID i4 is referred to, and the host-vehicle position mark d of D4 data is displayed at the front surface from the address c in accordance with the layer L4 and is also displayed at a location whose coordinate data is identical to the address appended to cut map image data a.

D5 data including the ID i4 is referred to, and the operation button e of the D5 data is displayed at the front surface from the host-vehicle position mark d in accordance with the layer L5 and is also displayed at a location whose coordinate data is identical to the address appended to cut map image data a.

That is, the control section 10 of the in-vehicle device 1 determines a display sequence according to the depths of the layers included in received D1 data to D5 data in the guide image displayed on the display/operation section 11. Data in a deep layer is superimposingly displayed at the rear surface from data in a shallow layer. In other words, the depth of the layer is data representing a preferential display sequence (priority) at the rear surface in the guide image displayed on the display/operation section 11 by the control section 10. As the layer is deep, the priority is low, and as the layer is shallow, the priority is high.

As described above, the control section 10 of the in-vehicle device 1 performs superimposing display on the guide image of the display/operation section 11 on the basis of data representing priority appended in the control section 20 of the mobile terminal 2. Thus, respective data having different transmission timing for use in the guide image is superimposingly displayed in an appropriate sequence.

If the superimposition processing has ended, the control section 10 of the in-vehicle device 1 ends the initialization processing and progresses to main processing.

<Main Processing>

The main processing is carried out for providing, acquiring, and displaying necessary data while the navigation system 100 is carrying out navigation processing.

During the main processing, control processing is carried out for providing, acquiring, and display necessary data while the in-vehicle device 1 and the mobile terminal 2 which constitute part of the navigation system 100 are carrying out the navigation processing.

The control section 10 of the in-vehicle device 1 or the control section 20 of the mobile terminal 2 changes each control processing time (each task) to be carried out into a short time of tens of milliseconds. That is, multitask processing is carried out for allocating the arithmetic processing time of the control section to the respective tasks. Hereinafter, respective control processing will be described separately.

<Decoration Data Control Processing>

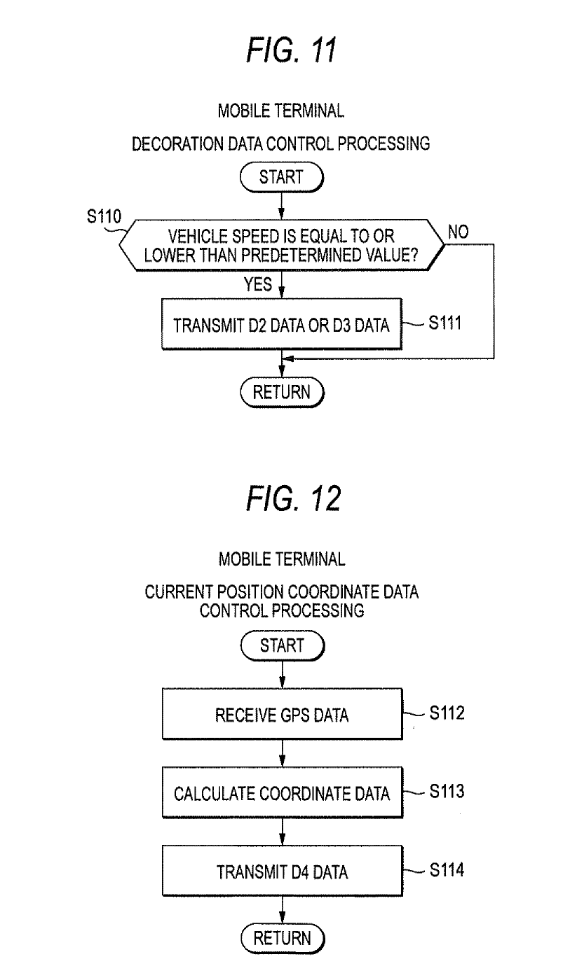

The control section 20 of the mobile terminal 2 carries out this control processing in a predetermined cycle (a period of tens of milliseconds) by a multitask control function and a decoration data control function. This control will be described on the basis of FIG. 11.

In S110, the control section 20 of the mobile terminal 2 receives data of the vehicle speed sensor provided in the vehicle from the in-vehicle device 1, and determines whether received vehicle speed data is equal to or lower than a predetermined value (for example, a state where the vehicle is traveling at 1 km/h or lower, or the vehicle is stopped). When it is determined that vehicle speed data is equal to or lower than the predetermined value (Yes in S110), the process progresses to S111. When it is determined that vehicle speed data is not equal to or lower than the predetermined value (No in S110), the process progresses to return.

In S111, the control section 20 of the mobile terminal 2 processes decoration data to D2 data or D3 data by the same processing as the above-described data processing, and transmits processed decoration data to the in-vehicle device 1. A predetermined amount of decoration data which is required for decorating a cut map image transmitted from the mobile terminal 2 to the in-vehicle device 1 and is not transmitted yet is transmitted. Thereafter, the process progresses to return.

Since the control section 20 transmits decoration data at such timing, there is no significant effect on update and display of the host-vehicle position mark d or cut map image data in the guide image displayed on the display/operation section 11 of the in-vehicle device 1. As the control section 20 of the mobile terminal 2 carries out more control processing, respective control processing tends to be delayed. In particular, since the update frequency of the host-vehicle position mark d superimposed and displayed on the guide image is high, other control processing should not be carried out as less as possible. At this timing, however, the vehicle is traveling at a low speed or is stopped, and it is no necessary to update the host-vehicle position mark d in the guide image. Even when update is required, update is carried out for slight movement of the vehicle, and update accuracy is not very required. Thus, there is little scene where update of the host-vehicle position mark d is required.

That is, decoration data is transmitted at this timing, such that update can be reliably carried out while the update frequency of the host-vehicle position mark d which is of significant importance as an element for exhibiting the navigation function from among decoration data and D4 data transmitted from the mobile terminal 2 to the in-vehicle device 1 is maintained high in the display/operation section 11 of the in-vehicle device 1, but update accuracy of decoration data which is of less importance is sacrificed.

<Current Position Coordinate Data Control Processing>

The control section 20 of the mobile terminal 2 carries out current position coordinate data control processing in a predetermined cycle (a cycle of tens of milliseconds) by a multitask control function and a current position coordinate data control function. This control will be described on the basis of FIG. 12.

In S112, the control section 20 of the mobile terminal 2 receives UPS data from the GPS satellites 4.

In S113, similarly to the current position coordinate data calculation processing, the control section 20 of the mobile terminal 2 calculates, on the basis of received GPS data, current position coordinate data representing the address of the route periphery map image data 1000 where the host-vehicle position mark d is located.

In S114, the control section 20 of the mobile terminal 2 processes current position coordinate data to D4 data by the same processing as the above-described data processing, and transmits processed data to the in-vehicle device 1. Thereafter, the process progresses to return.

During this control processing, the transmission cycle of D4 data to the in-vehicle device 1 is shorter than the transmission cycle of D1 data during cut map image control processing described below since the control section 20 necessarily carries out the control processing in a cycle based on the multitask control function.

<Cut Map Image Control Processing>

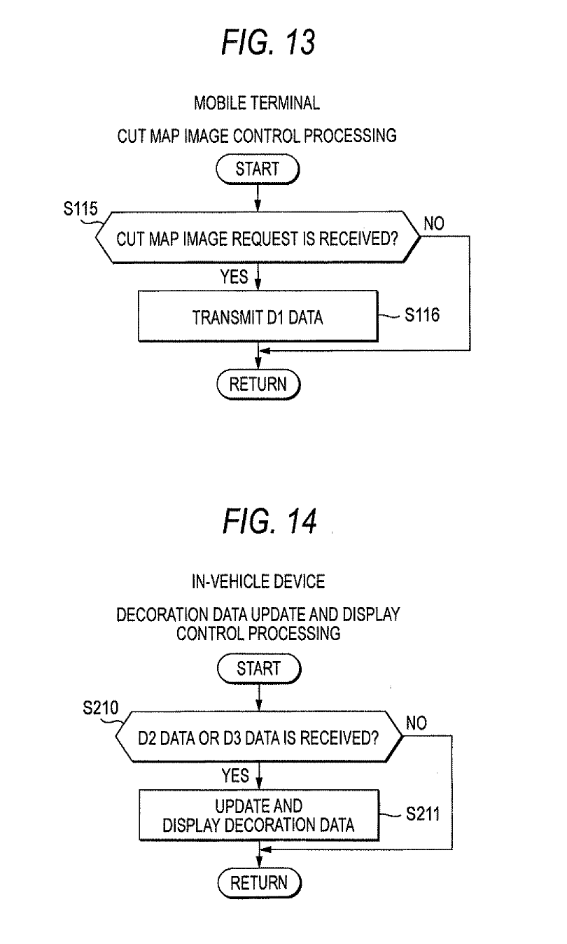

The control section 20 of the mobile terminal 2 carries out cut map image control processing in a predetermined cycle (a cycle of tens of milliseconds) by a multitask control function and a cut image control function. This control will be described on the basis of FIG. 13.

In S115, the control section 20 of the mobile terminal 2 determines whether or not a transmission request of cut map image data is received from the in-vehicle device 1. When it is determined that the transmission request is received (Yes in S115), the process progresses to S116. When it is determined that the transmission request is not received (No in S115), the process progresses to return.

In S116, the control section 20 of the mobile terminal 2 processes requested cut map image data to D1 data by the same processing as the above-described data processing and transmits processed data to the in-vehicle device 1. Thereafter, the process progresses to return.

During this control processing, transmission of D 1 data to the in-vehicle device 1 is carried out only when the control section 10 receives the transmission request of cut map image data from the in-vehicle device 1. Specifically, the transmission request is transmitted by the control section 10 only when cut map image data is updated during cut map image data update and display control processing (described below) which is carried out by the control section 10 of the in-vehicle device 1, Thus, the transmission cycle of D1 data to the in-vehicle device 1 is more extended than the transmission cycle of D4 data during the current position coordinate data control processing.

<Decoration Data Update and Display Control Processing>

The control section 10 of the in-vehicle device 1 carries out cut map image control processing in a predetermined cycle (a cycle of tens of milliseconds) by a multitask control function and a decoration data update and display control function. This control will be described on the basis of FIG. 14.

In S210, the control section 10 of the in-vehicle device 1 determines whether D2 data or D3 data is received from the mobile terminal 2 or not. When it is determined that D2 data or D3 data is received (Yes in S210), the process progresses to 5211. When it is determined that D2 data or D3 data is not received (No in S210), the process progresses to return.

In S211, the control section 10 of the in-vehicle device 1 stores D2 data or D3 data received from the mobile terminal 2 in the storage section 14, and the control section 10 carries out the same superimposing display processing as the above-described superimposing display processing for D4 data stored in the storage section 14. Thereafter, the process progresses to return.

<Host-Vehicle Position Mark Update and Display Control Processing>

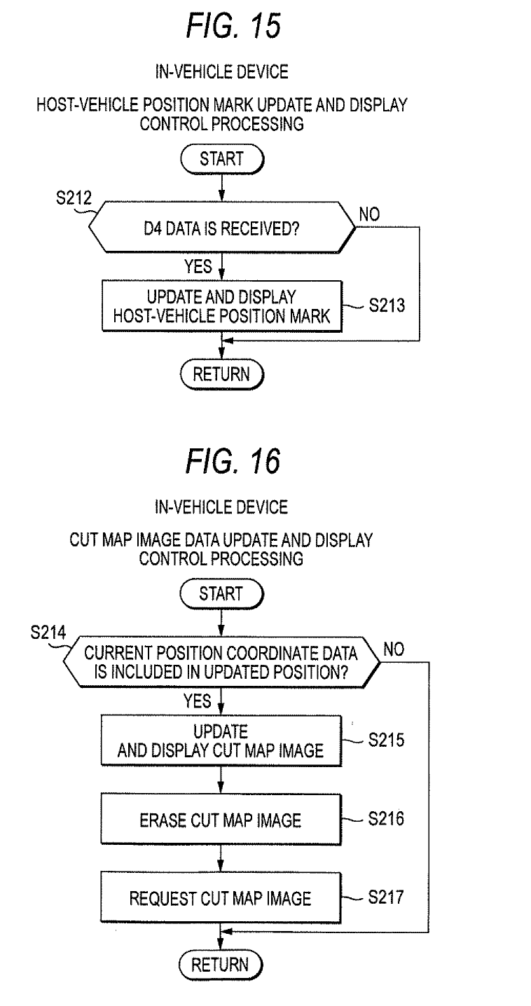

The control section 10 of the in-vehicle device 1 carries out cut map image control processing in a predetermined cycle (a cycle of tens of milliseconds) by a multitask control function and a host-vehicle position mark update and display function. This control will be described on the basis of FIG. 15.

In S212, the control section 10 of the in-vehicle device 1 determines whether or not D4 data is received from the mobile terminal 2. When it is determined that D4 data is received (Yes in S212), the process progresses to S213. When it is determined that D4 data is not received (No in S212), the process progresses to return.

In S213, the control section 10 of the in-vehicle device 1 stores D4 data received from the mobile terminal 2 in the storage section 14. The control section 10 carries out the same superimposing display as the above-described superimposing display processing for D4 data stored in the storage section 14. Thereafter, the process progresses to return.

<Cut Map Image Data Update and Display Control Processing>

The control section 10 of the in-vehicle device 1 carries out cut map image control processing in a predetermined cycle (a cycle of tens of milliseconds) by a multitask control function and a cut map image data update and display control function. This control will be described on the basis of FIG. 16.

In S214, the control section 10 of the in-vehicle device 1 determines whether or not current position coordinate data included in D4 data received from the mobile terminal 2 is included in an update region y of cut map image data M5 shown in FIG. 18. The update region y refers to a region having a predetermined width in the periphery of cut map image data in the guide image displayed on the display/operation section 11, that is, an edge. When it is determined that current position coordinate data is included in the update region y of cut map image data (Yes in S214), the control section 10 of the in-vehicle device 1 progresses to S215. When it is not determined that current position coordinate data is included in the update region y of the map image (No in S214), the process progresses to return.

In S215, the control section 10 of the in-vehicle device 1 superimposes and displays a predetermined number (for example, nine) of cut map image data, which is stored in the storage section 14 and should be next displayed on the display/operation section 11, on other kinds of data in the guide image displayed on the display/operation section 11. When the host-vehicle position mark d is included in the update region y in the guide image displayed on the display/operation section 11 by the control section 10 of the in-vehicle device 1, if the host-vehicle position mark d is located at an upper part of cut map image data, cut map image data which should be next displayed refers to adjacent cut map image data on the upper side of relevant cut map image data. If the host-vehicle position mark d is located at a lower part of cut map image data, cut map image data which should be next displayed refers to adjacent cut map image data on the lower side of relevant cut map image data. If the host-vehicle position mark d is located at a right part of cut map image data, cut map image data which should be next displayed refers to adjacent cut map image data on the right side of relevant cut map image data. If the host-vehicle position mark d is located at a left part of cut map image data, cut map image data which should be next displayed refers to adjacent cut map image data on the left side of relevant cut map image data.

For example, referring to FIG. 18, when the host-vehicle position mark d in cut map image data M5 is updated and displayed so as to move to the update region y at the upper part of cut map image data M5 along the route z, the control section 10 of the in-vehicle device 1 updates and displays adjacent cut map image data M8 on the upper side of cut map image data M5 in the guide image displayed on the display/operation section 11. Similarly, when the host-vehicle position mark d is updated and displayed so as to be deviated from the route z and to move to the update region y at the lower part, the right part, or the left part of cut map image data M5, cut map image data M2, M3, M4, or M8 adjacent to cut map image data M5 is selected, and updated and displayed in the guide image displayed on the display/operation section 11. Thereafter, the process progresses to S207.

The control section 10 determines the adjacency relationship of cut map image data on the basis of the addresses appended to cut map image data.

In S216, the control section 10 of the in-vehicle device 1 erases cut map image data stored in the storage section 14 when cut map image data is updated and displayed. With regard to this erasure, when nine pieces of cut map image data stored in the storage section 14 are successively arranged, the control section 10 erases, on the basis of cut map image data before update, cut map image data in a direction opposite to a direction (hereinafter, referred to as an update direction) from cut map image data before update and cut map image data after update and cut map image data on both sides of relevant cup map image data.

For example, referring to FIG. 18, when the host-vehicle position mark d in cut map image data M5 is updated and displayed so as to move to the update region y at the upper part of cut map image data M5 along the route z, the control section 10 of the in-vehicle device 1 updates and displays adjacent cut map image data M8 on the upper side of cut map image data M5 in the guide image displayed on the display/operation section 11, and erases, on the basis of cut map image data M5 before update, cut map image data M2 in a direction opposite to the update direction from cut map image data M5 before update to cut map image data M8 after update and adjacent cut map image data M1 and M3 on both sides of cut map image data M2. Similarly, when the host-vehicle position mark d which is deviated from the route z is updated and displayed so as to move to the update region y at the lower part, the left part, or the right part of cut map image data M5, cut map image data adjacent to cut map image data M5 is updated and displayed in the guide image displayed on the display/operation section 11, and on the basis of cut map image data M5 before update, cut map image data in a direction opposite to the update direction from cut map image data M5 before update to cut map image data after update and adjacent cut map image data on both sides of relevant cut map image data are erased. Thereafter, the process progresses to S217.

In S217, the control section 10 of the in-vehicle device 1 transmits a signal to request transmission of three pieces of new cut map image data to the mobile terminal 2 since in Step S216, three pieces of cut map image data stored in the storage section 14 are erased and six pieces of cut map image data remain from among nine pieces of cut map image data. That is, the control section 10 performs control in collaboration with the mobile terminal 2 such that a predetermined number of pieces (for example, nine) of cut map image data is necessarily stored in the storage section 14. Cut map image data which is newly requested by the control section 10 includes cut map image data in the update direction of cut map image data after update and cut map image data on both sides of relevant cut map image data. Thus, the control section 10 transmits the IDs of requested cut map image data to the mobile terminal 2.

For example, referring to FIG. 18, when the host-vehicle position mark d in cut map image data M5 is updated and displayed so as to move to the update region y at the upper part of cut map image data M5 along the route z, the control section 10 of the in-vehicle device 1 updates and displays adjacent cut map image data M8 on the upper side of cut map image data M5 on the display/operation section 11, and transmits the IDs cut map image data in the update direction of cut map image data M8 and adjacent cut map image data on both sides of cut map image data M8 to the mobile terminal 2. That is, the IDs of cut map image data M12 and adjacent cut map image data M11 and M13 on both sides of cut map image data M12 in FIG. 17 are transmitted to the mobile terminal 2.

Instead of transmitting the IDs of requested cut map image data to the mobile terminal 2, the ID of updated and displayed cut map image data may be transmitted to the mobile terminal 2, the control section 20 of the mobile terminal 2 may determine cut map image data which should be next transmitted, and determined cut map image data may be transmitted to the in-vehicle device.

<Guidance End Determination Processing>

The control section 10 of the in-vehicle device 1 determines whether coordinate data received from the mobile terminal 2 is included in a destination or not by a guidance end determination function. That is, since the navigation system 100 is to guide the user to the destination, when current position coordinate data is included in the destination which is included in cut map image data, it is regarded that the vehicle has reached the destination, and the navigation system 100 stops. Thus, when it is determined that current position coordinate data received from the mobile terminal is included in the destination, the control section 10 transmits an end notification indicating the end of guidance to the mobile terminal 2.

The control section 20 of the mobile terminal 2 determines whether the end notification is received or not, and when it is determined that the end notification is received, ends navigation control, such as current position coordinate data calculation processing or current position coordinate data transmission processing.

The navigation system 100 uses a navigation method in which the host-vehicle position mark d is updated and displayed so as to move on cut map image data in accordance with the movement of the vehicle while maintaining cut map image data which constitutes the guide image displayed on the display/operation section 11 of the in-vehicle device 1, and only when the host-vehicle position mark d moves away from cut map image data, cut map image data is updated and displayed.

For this reason, in the in-vehicle device 1, it is possible to avoid a situation that the acquisition processing of cut map image data having a comparatively large amount of data may be delayed due to delay of the communication speed, and cut map image data corresponding to the host-vehicle position mark d representing the current position may not be superimposed in the guide image displayed on the display/operation section 11 of the in-vehicle device 1. In other words, the host-vehicle position mark d can be reflected in the guide image substantially in real time. That is, the correspondence relationship between the current position data of the vehicle and map image data superimposed in the guide image can be constantly established so as to represent the actual position of the vehicle.

When this navigation method is used, at a scene where the host-vehicle position mark d and cut map image data should be updated on the display/operation section 11 of the in-vehicle device 1, the host-vehicle position mark d is updated more frequently. With regard to the amount of data when the host-vehicle position mark d and cut map image data are updated, cut map image data has a larger amount of data. In such a situation, the mobile terminal 2 decreases the transmission frequency of cut map image data, which is updated less frequently and has a larger amount of data than the host-vehicle position mark d, less than the transmission frequency of the host-vehicle position mark. In other words, the transmission frequency of the host-vehicle position mark which is updated more frequently and has a smaller amount of data than cut map image data increases more than the transmission frequency of cut map image data.

For this reason, there is no case where communication between the mobile terminal 2 and the in-vehicle device 1 or the like is delayed, and the host-vehicle position mark d can be reflected in the guide image substantially in real time. That is, the correspondence relationship between current position data of the vehicle and map image data superimposed in the guide image can be constantly established so as to represent the actual position of the vehicle.

### 2. Second Embodiment

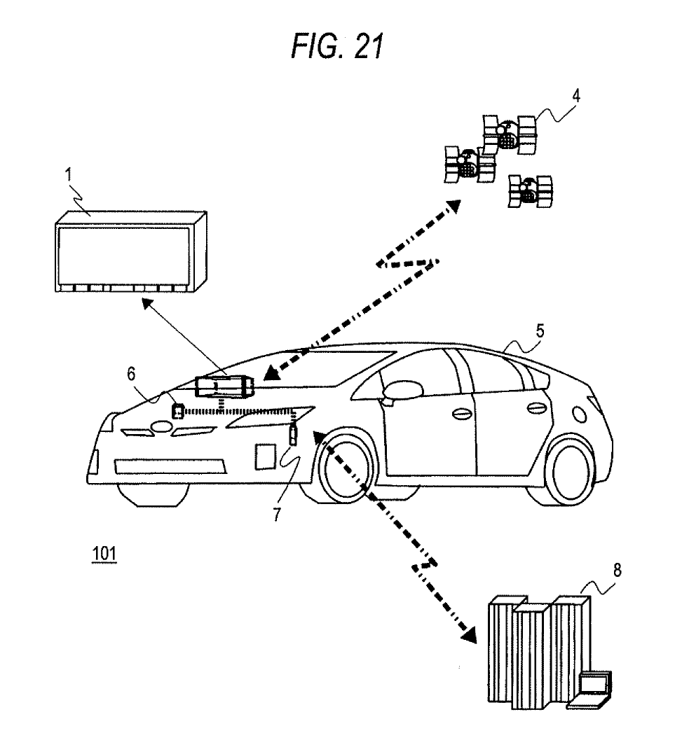

Next, a second embodiment will be described. Although in the first embodiment, the navigation system includes the in-vehicle device 1 and the mobile terminal 2 and the server 3 serving as a data providing apparatus, as shown in FIG. 21, a navigation system 101 may include an in-vehicle device 1 and a server 3 serving as a data providing apparatus while no mobile terminal 2 is provided.

In this case, communication is performed between the in-vehicle device 1 and the server 3 to implement the navigation function. The in-vehicle device 1 includes a communication section which performs communication with the server 3 to transmit and receive data regarding navigation. The server 3 includes a communication section which performs communication with the in-vehicle device 1 to transmit and receive data regarding navigation.

Although in the foregoing embodiment, a case has been described where the control section 20 of the mobile terminal 2 uses the current position coordinate data calculation function to calculate current position coordinate data representing where the host-vehicle position mark is located on route periphery map image data on the basis of GPS data received by the GPS communication section 27, in this embodiment, the control section 30 of the server 3 carries out the relevant processing.

Although a case has been described where the control section 20 uses the map image cutting processing function to carry out the processing for cutting data suitable for a display size in the guide image displayed on the display/operation section 11 of the in-vehicle device 1 from route periphery map image data received from the server 3 by the communication section 28, in this embodiment, the control section 30 of the server 3 carries out the relevant processing.

Although a case has been described where the control section 20 uses the route data processing function to carry out the processing for processing cut map image data, decoration data received from the server 3 by the communication section 28, and current position coordinate data, in this embodiment, the control section 30 of the server 3 carries out the relevant processing.

Although a case has been described where the control section 20 uses the map matching function to carry out the map matching processing on the basis of vehicle information acquired from the in-vehicle device 1, in this embodiment, the control section 30 of the server 3 carries out the relevant processing.

Although a case has been described where the control section 20 uses the decoration data control processing function to carry out the processing for transmitting decoration data on the basis of vehicle speed data received from the in-vehicle device 1 by the near field communication section 29, in this embodiment, the control section 30 of the server 3 carries out the relevant processing.

Although a case has been described where the control section 20 uses the current position coordinate data control processing function to carry out the processing for calculating the coordinates of cut map image data where the host-vehicle position mark d on the basis of GPS data received by the GPS communication section 27 and transmitting calculated data to the in-vehicle device 1 at a predetermined timing, in this embodiment, the control section 30 of the server 3 having received GPS data carries out the relevant processing.

Although a case has been described where the control section 20 uses the cut map image data control function to carry out the processing for transmitting the cut map image to the in-vehicle device 1 at a predetermined timing, in this embodiment, the control section 30 of the server 3 carries out the relevant processing.

Although all of the above-described processing are carried out by the control section 30 of the server 3, some kinds of processing may be carried out by the control section 10 of the in-vehicle device 1.

Although the embodiments of the invention have been described, the invention is not limited to the foregoing embodiments, and can be modified in various forms. Hereinafter, other embodiments will be described. Of course, the following embodiments may be appropriately combined with each other.

<Modification 1>

Although, in the first embodiment, a case has been described where the control section 20 of the mobile terminal 2 uses the multitask control function and the current position coordinate data control function to carry out the current position coordinate data control processing in a predetermined cycle (a cycle of tens of milliseconds), the current position coordinate data control processing may be carried out on the basis of vehicle speed data received from the in-vehicle device 1.

That is, the control section 20 of the mobile terminal 2 controls current position coordinate data in accordance with the vehicle speed. When the vehicle speed is low, the cycle in which the current position coordinate data control processing is carried out is more extended than a predetermined cycle. For example, when the vehicle speed is equal to or lower than 20 Km/h, the control section 20 carries out the current position coordinate data control processing in a cycle of 1 second.

To the contrary, when the vehicle speed is high, the cycle in which the current position coordinate data control processing is carried out is shortened less than a predetermined cycle. For example, when the vehicle speed is equal to or higher than 40 Km/h, the control section 20 carries out the current position coordinate data control processing in a cycle of 20 milliseconds.

In the guide image displayed on the display/operation section 11 of the in-vehicle device 1, when the vehicle speed is low, if the host-vehicle position mark d is updated frequently, update display is not carried out such that the host-vehicle position mark d is moved significantly, and even when the host-vehicle position mark d is substantially located at the same position, update display is carried out for the substantially same position, which leads to wasteful processing. Thus, the current position coordinate data control processing is carried out at such timing, such that the load imposed on the control section 20 of the mobile terminal 2 can be reduced, and other control processing can be smoothly carried out with no delay.

<Modification 2>

Although in the first embodiment, a case has been described where the GPS communication section is provided in the mobile terminal 2, the GPS communication section may be provided in the in-vehicle device 1, and the control section 10 of the in-vehicle device 1 may carry out processing for transmitting current position data of the vehicle received by the GPS communication section to the mobile terminal 2 at a predetermined timing.

Although in the foregoing embodiments, a case has been described where various functions are implemented by software through the arithmetic processing of the CPU based on the program, some of the functions may be implemented by electrical hardware. To the contrary, some of functions which are implemented by hardware circuits may be implemented by software.

Although in the flowcharts illustrating control of the respective embodiments, for convenience, the processing is shown in a single train, the control section may use the multitask control function to carry out the segmented processing in parallel.

What is claimed is:

1. A navigation system, comprising:
an in-vehicle device mounted on a vehicle; and
a data providing apparatus that provides data regarding navigation to the in-vehicle device,
wherein the data providing apparatus includes:
a detection unit that detects current position data of the vehicle;
an accumulation unit that accumulates map image data;
a map image cutting unit that cuts the map image data in a display size of the in-vehicle device; and
a transmission unit that separately transmits the current position data which is detected by the detection unit and the cut map image data which is cut by the map image cutting unit to the in-vehicle device,
wherein the in-vehicle device includes:
a reception unit that receives the current position data and the cut map image data from the data providing apparatus; and
a display unit that superimposes the received current position data and the cut map image data to display a guide image,
wherein the transmission unit transmits the current position data in a first transmission cycle and transmits the cut map image data in a second transmission cycle which is shorter than the first transmission cycle, and
wherein the display unit updates the current position data while maintaining the cut map image data when the reception unit receives the current position data, and updates the cut map image data when the current position data is located at an update position in the periphery of the cut map image data.

2. The navigation system as set forth in claim 1,
wherein the data providing apparatus further includes a vehicle speed detection unit that detects a vehicle speed of the vehicle,
wherein the transmission unit transmits decoration data for decorating the cut map image data to the in-vehicle device when the vehicle speed is equal to or lower than a predetermined vehicle speed, and
wherein the display unit superimposes the received current position data, the cut map image data and the decoration data to display the guide image.

3. The navigation system as set forth in claim 1,
wherein the transmission unit transmits display sequence data which indicates a sequence for superimposing the current position data and the cut map image data to display the guide image, and
wherein the display unit superimposes the current position data and the cut map image data on the basis of the display sequence data.

4. The navigation system as set forth in claim 1,
wherein the map image cutting unit cuts a route map image according to a guidance route to a destination and an adjacent map image adjacent to the route map image as the cut map image data, and
wherein the display unit of the in-vehicle device selects one of the route map image and the adjacent map image as the cut map image data for use in the guide image on the basis of the current position data.

5. An in-vehicle device that is mounted on a vehicle and that receives data regarding navigation from a data providing apparatus, wherein the data providing apparatus detects current position data of the vehicle, accumulates map image data, cuts the map image data in a display size of the in-vehicle device, and separately transmits the detected current position data and the cut map image data to the in-vehicle device, and wherein the data providing apparatus transmits the detected current position data in a first transmission cycle and transmits the cut map image data in a second transmission cycle which is shorter than the first transmission cycle, the in-vehicle device comprising:
a reception unit that receives the current position data and the cut map image data from the data providing apparatus; and
a display unit that superimposes the received current position data and the cut map image data to display a guide image,
wherein the display unit updates the current position data while maintaining the cut map image data when the reception unit receives the current position data, and updates the cut map image data when the current position data is located at an update position in the periphery of the cut map image data.

6. The in-vehicle device as set forth in claim 5,
wherein the reception unit receives display sequence data which indicates a sequence for superimposing the current position data and the cut map image data to display the guide image, from the data providing apparatus, and
wherein the display unit superimposes the current position data and the cut map image data on the basis of the display sequence data.

7. A navigation method for a navigation system including: an in-vehicle device which is mounted on a vehicle; and a data providing apparatus which provides data regarding navigation to the in-vehicle device, the navigation method comprising:
a detection step of causing the data providing apparatus to detect current position data of the vehicle;
a map image cutting step of causing the data providing apparatus to cut map image data which is accumulated in the data providing apparatus in a display size of the in-vehicle device;
a transmission step of causing the data providing apparatus to separately transmit the detected current position data and the cut map image data to the in-vehicle device;
a reception step of causing the in-vehicle device to receive the current position data and the cut map image data from the data providing apparatus; and
a display step of causing the in-vehicle device to superimposes the received current position data and the cut map image data to display a guide image,
wherein in the transmission step, the current position data is transmitted in a first transmission cycle and the cut map image data is transmitted in a second transmission cycle which is shorter than the first transmission cycle, and
wherein in the display step, the current position data is updated while maintaining the cut map image data when the current position data is received, and the cut map image data is updated when the current position data is located at an update position in the periphery of the cut map image data.

8. A computer-readable medium recording a program which is executable in a computer of an in-vehicle device that is mounted on a vehicle and that receives data regarding navigation from a data providing apparatus, wherein the data providing apparatus detects current position data of the vehicle, accumulates map image data, cuts the map image data in a display size of the in-vehicle device, and separately transmits the detected current position data and the cut map image data to the in-vehicle device, and wherein the data providing apparatus transmits the detected current position data in a first transmission cycle and transmits the cut map image data in a second transmission cycle which is shorter than the first transmission cycle, the program which causes the computer of the in-vehicle device to perform a navigation method comprising:
a reception step of causing the in-vehicle device to receive the current position data and the cut map image data from the data providing apparatus; and
a display step of causing the in-vehicle device to superimposes the received current position data and the cut map image data to display a guide image,
wherein in the display step, the current position data is updated while maintaining the cut map image data when the current position data is received, and the cut map image data is updated when the current position data is located at an update position in the periphery of the cut map image data.
